(19) United States
(12) Patent Application Publication
(10) Pub. No.: US 2002/0111971 A1
(43) Pub. Date: Aug. 15, 2002

(54) Method for dynamic server side timer control bar insertion

(76) Inventors: Daniel J. Kutcher, Dana Point, CA (US); Thomas C. Amon, Santa Ana, CA (US)

Correspondence Address: STETINA BRUNDA GARRED & BRUCKER, 75 ENTERPRISE, SUITE 250, ALISO VIEJO, CA, 92656, US

(21) Appl. No.: 09/999,595

(22) Filed: Nov. 15, 2001

Related U.S. Application Data
(60) Provisional application No. 60/249,867, filed on Nov. 17, 2000.

(51) Int. Cl. G06F 15/00

(52) U.S. Cl. 707/520

(57) ABSTRACT

The present invention may be regarded as a method for dynamically inserting a control bar with a timer into a page. The method receives at a server a page to send to a client for display. The server dynamically inserts into the page a control bar and control information for generating a timer display on the page.

### CROSS-REFERENCE TO RELATED APPLICATIONS

This application claims the benefit of U.S. Provisional Application Ser. No. 60/249,867, filed Nov. 17, 2000, the entire contents of which are hereby incorporated by reference.

### BACKGROUND OF THE INVENTION

The present invention relates generally to control of computer-generated displays and more particularly to dynamically inserting a control bar including a timer into a web page display.

Computer systems in general are known. A typical computer system includes a computer, a keyboard, a mouse, and a monitor. Additionally, the computer includes a central processing unit (CPU) and random access memory (RAM) and allows various software programs to be used. Further, the computer system may include a modem, an Ethernet card or other similar device for connecting to a system of networked computers, such as the Internet.

The Internet provides a useful technique for making information available to a variety of individuals each of whom may be located at a variety of different locations. Indeed, within the vast Internet environment, individuals can access information tools from remote locations. The Internet, which originally came about in the late 1960's, is a computer network made up of many smaller networks spanning the entire globe. The host computers or networks of computers on the Internet allow public or private access to databases containing information in numerous areas of expertise. Hosts can be sponsored by a wide range of entities including, for example, universities, government organizations, commercial enterprises and individuals.

Internet information is made available to the public through servers running on an Internet host. The servers make documents or other files available to those accessing the host site. Such files can be stored in databases and on storage media such as, for example, optical or magnetic storage devices, preferably local to the host.

Networking protocols can be used to facilitate communications between the host and a requesting client. Transmission Control Protocol/Internet Protocol (TCP/IP) is one such networking protocol. Computers on a TCP/IP network utilize unique identification codes allowing each computer or host on the Internet to be uniquely identified. Such codes can include an Internet Protocol (IP) number or address and corresponding network and computer names.

Created in 1991, the World-Wide Web (Web, or www) provides access to information on the Internet, allowing a user to navigate Internet resources intuitively, without IP addresses or other specialized knowledge. The Web comprises hundreds of thousands of interconnected “pages” or documents that can be displayed on a user's computer monitor. The web pages are provided by hosts running special servers. Software that runs these web servers is relatively simple and is available on a wide range of computer platforms including personal computers (PCs). Equally available is web browser software used to display web pages, as well as traditional non-web files, on the user's system.

The Web is based on the concept of hypertext and a transfer method known as Hypertext Transfer Protocol (HTTP). HTTP is designed to run primarily over TCP/IP and uses the standard Internet setup where a server issues the data and a client displays or processes the data. One format for information transfer is to create documents using Hypertext Markup Language (HTML). HTML pages are made up of standard text as well as formatting codes indicating how to display the page. A browser reads these codes to display the page. The Web also uses the File Transfer Protocol (FTP) to transmit files between hosts. In particular, a method known as “anonymous FTP” allows a user to receive a file from a server without the server learning the identity of the user.

Each web page may contain pictures and sounds in addition to text. Associated with certain text, pictures or sounds are connections, known as hypertext links, to other pages within the same server or even on other computers within the Internet. For example, links may appear as underlined or highlighted words or phrases. Each link is directed to a web page by using a special name called a Uniform Resource Locator (URL). URLs enable the browser to go directly to the associated resource, even if it is on another web server.

In addition to the Internet which allows for general, public retrieval of information, other means of accessing such information exist and are commonly utilized. For example, direct modem connections between two computers, proprietary internal networks within large institutions and organizations, or the like, are equally available and useful means for accessing catalogued information stored in databases.

Some web pages and web sites provide media data. This data can be downloaded or presented as streaming data to a user. Streaming data may be the continuous transmission of data, for example, audio or video data. It is desirable for a provider of such data to transmit such data to a user quickly and reliably. Therefore, a need exists for a system for electronically transmitting electronic media data.

It has appeared desirable to provide automatic injection of advertising content into a client side display from the server side at a selected point during a web browsing session. It has further appeared desirable in conjunction with presentation of such advertising content to provide a visible timer, for example, to alert the user to the fact that the advertisement being viewed will persist for only a short time interval.

### BRIEF SUMMARY OF THE INVENTION

An aspect of the present invention may be regarded as a method for dynamically inserting a control bar with a timer into a page. The method receives at a server a page to send to a client for display. The server dynamically inserts into the page a control bar and control information for generating a timer display on the page.

The server then transmits the page to the client.

The control information may include an amount of time to display the page.

Display of the page may be terminated when the client (user) selects a link. The link value may be replaced with a control code so that when a user selects the link, tracking can be performed at the server.

The control bar includes a timer bar counting down the time left for displaying the page.

The control bar may include a “pause” button for pausing the count down timer. Pressing the “pause” button will change the “pause” button to a “continue” button for resuming the count down timer. The control bar may include one or more logos.

The control bar may include an “exit” button for terminating the display of the page.

The control bar may be segregated into segments which may be displayed at different locations on the page. For example, the “exit” button may be in a segment. The segment including the “exit” button may be displayed at the bottom of the page.

The page may be an advertisement. The advertisement may be received by the server from an external source.

### BRIEF DESCRIPTION OF THE DRAWINGS

These, as well as other features of the present invention, will become apparent upon reference to the drawings, wherein:

FIG. 1 illustrates a computer display screen having a control bar that includes a timer;

FIG. 2 illustrates changing the “pause” button in the control bar shown in FIG. 1 to a “continue” button when the “pause” button is pressed;

FIG. 3 illustrates an exemplary web page to be scanned and delivered to a client by a server; and

FIGS. 4-6 illustrate exemplary alternative control bar embodiments.

### DETAILED DESCRIPTION OF THE INVENTION

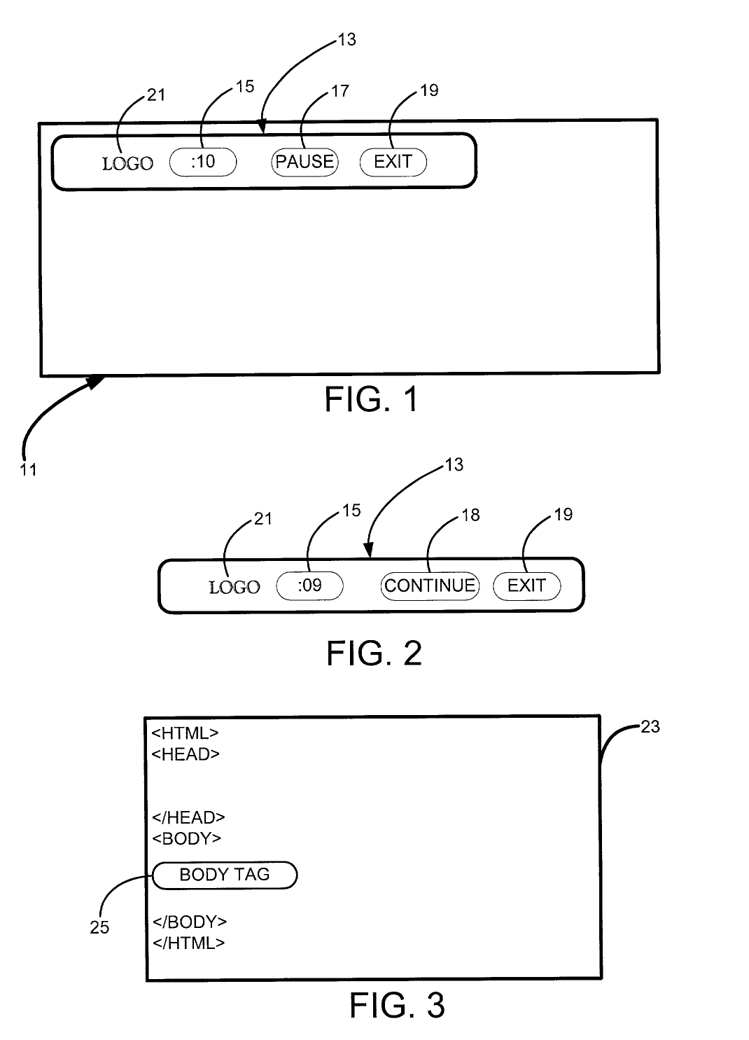

FIG. 1 illustrates a computer display screen 11 having a control bar 13, which includes a timer display. The screen 11 may form the display component of a client side system including a computer such as a personal computer (PC) running a web browser.

The control bar 13 includes a count down display area 15, a pause button 17 and an exit button 19. A logo 21, such as, a company logo, may also be displayed.

In operation, the timer display area 15 depicts the amount of time during which the adjoining screen information will be displayed, such as, for example, “10” for ten seconds. Once the display appears, the timer 15 begins to count down to zero, e.g., 10, 9, 8, etc. The actual duration of the count may be any selected amount of time. During this count down, the viewer can click on the “pause” button 17 to stop the count down and freeze the display. The viewer may also click the “exit” button 19 to terminate the screen display. If the user clicks the “pause” button 17, the “pause” button 17 is replaced in the display by a “continue” button 18 as shown in FIG. 2.

An exemplary mechanism for implementing the timer display shown in FIGS. 1 and 2 is now described in connection with FIG. 3. FIG. 3 depicts a web page 23 to be scanned and delivered to the client side by a server. The web page may be, for example, an advertisement received by the server from another source. The server proceeds to dynamically insert information into the web page required to generate the control bar 13 and to control the timer display.

As the web page 23 is created “on the fly,” the control bar display information is inserted into the body portion of the page 23. This information typically provides a control bar display as shown in FIG. 1, but can be varied to, for example, change the location of the control bar or to move or delete features of the bar such as the “exit” button 19. The exit button 19 may be moved, for example, to the lower right corner of the display so as to require the user to scroll through an advertisement. The timer may be located on the left side of the display and the exit button on the right side to balance the display.

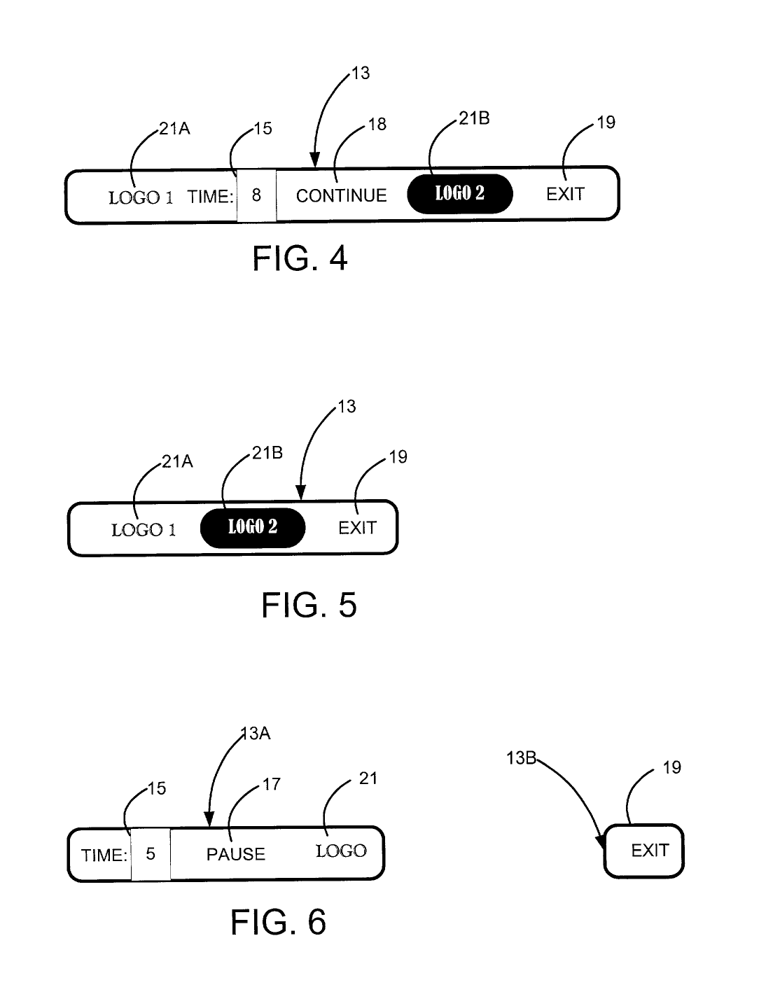

Alternate control bar embodiments and placements are illustrated in FIGS. 4, 5 and 6. For example, as shown in FIG. 4, the control bar 13 may include multiple logos 21A and 21B. It is possible that in some embodiments, such as the one shown in FIG. 5, the control bar 13 does not have a count down timer 15 or a pause button 17 and continue button 18. Also, as described above, the control bar may be split into multiple segments. For example, as shown in FIG. 6, one segment 13B may include an exit button 19 and be located away from another control bar segment 13A. For example, control bar segment 13A may be located at the top of the page and the control bar segment 13B having the exit button 19 may be located at the bottom of the page.

The timer control logic is inserted into the body tag 25 of the web page 23. This logic sets the amount of time, starts the timer, and conducts the count down and display of the count down. The timer control logic also terminates the count down if a link is clicked by the user on the client side.

As will be appreciated, the invention facilitates dynamic generation and insertion of a control bar into a display. For example, 100 different ads can be sent down from the server to 100 different clients with the same control bar being inserted into each of the ads regardless of the other contents of the advertisement. Advertisers can also be provided with certain options as to placement of control bar features, as discussed above.

Another advantage can be achieved during dynamic control bar insertion by replacing the value of a link in the body of the page 23 with a control code that points back to the server, such that when the user selects the link on the display, the user is taken through the server for tracking purposes and is then forwarded to the destination represented by the link that he or she selected.

What is claimed is:

1. A method comprising:
(a) receiving, at a server, a page to send to a client for display; and
(b) dynamically inserting into the page a control bar and control information for generating a timer display on the page.

2. The method of claim 1, further comprising transmitting the page to the client.

3. The method of claim 1, wherein the control information comprises an amount of time for a display of the page.

4. The method of claim 3, wherein the display of the page is terminated if the client selects a link.

5. The method of claim 4, wherein (b) further comprises replacing a link value for the link with a control code that points back to the server; and further comprising performing tracking at the server when the client selects the link.

6. The method of claim 3, wherein the timer display comprises a count down timer that decrementally displays a time left for a display of the page.

7. The method of claim 6, wherein the timer display further comprises a pause button for pausing the count down timer.

8. The method of claim 7, wherein depression of the pause button replaces the pause button with a continue button that resumes the count down timer.

9. The method of claim 1, wherein the control bar comprises a logo.

10. The method of claim 9, wherein the control bar comprises a plurality of logos.

11. The method of claim 1, wherein the control bar comprises an exit button for terminating display of the page.

12. The method of claim 1, wherein the control bar is segregated into a plurality of control bar segments, each of the plurality of control bar segments being located at a different location on the page than the other control bar segments.

13. The method of claim 12, wherein one of the control bar segments includes an exit button.

14. The method of claim 13, wherein the control bar segment including the exit button is located at the bottom of the page.

15. The method of claim 1, wherein the page is an advertisement.

16. The method of claim 15, wherein the advertisement is received at the server from an external source.
